(19) United States
(12) Patent Application Publication
(10) Pub. No.: US 2007/0073890 A1
(43) Pub. Date: Mar. 29, 2007

(54) Integration of resource management with calendared appointments

(76) Inventors: Gerd M. Ritter, Heidelberg (DE); Volkmar Stegmann, Altlussheim (DE); Hamid Moghaddam, Osterburken (DE); Amit Khanna, Wynnewood, PA (US)

Correspondence Address: FISH & RICHARDSON, P.C., PO BOX 1022, MINNEAPOLIS, MN, 55440-1022, US

(21) Appl. No.: 11/237,317

(22) Filed: Sep. 27, 2005

(51) Int. Cl. G06F 15/16

(52) U.S. Cl. 709/229

(57) ABSTRACT

First data identifying a resource, a calendared appointment associated with the resource, and a participant in the calendared appointment may be received and subsequently associated with second data (e.g., at least one link to information available via a communications network and/or a data file). Thereafter, third data may be transmitted over the communications network to a node associated with the participant to modify the calendared appointment to include the second data. In one variation, data identifying a resource and a calendared appointment associated with the resource may be received via a communications network. Based on such data, a usage statistic may be calculated for the resource based on a length of time of the calendared appointment. Related apparatuses, systems, computer program products are also described.

### TECHNICAL FIELD

The subject matter described herein relates to reserving resources and providing resource planning based on calendared appointments.

### BACKGROUND

Most enterprises have certain resources that are limited in number and are shared among multiple employees, organizational units, projects, and/or processes. Such resources are typically not assigned to, for example, any particular employee, but rather, are made temporarily available based on need. Shared resources may include meeting rooms or meeting room equipment (e.g., portable projector, laptop computer, etc.), tools for repairing customer equipment (e.g., drills, electric generators, etc.), product samples and associated promotional materials (e.g., a high value sample product made available to a customer on a short-term trial basis), and the like. Company resources may also include employees providing services both internally and externally such as maintenance technicians, in-house attorneys, information technology professionals, and accountants.

As the demand for certain resources may exceed availability of such resources, companies often implement a system by which employees may determine the availability of resources and reserve resources (e.g., make an appointment) using a resource planning tool. However, conventional resource planning tools suffer from several drawbacks. They are often complex, time consuming, and require special training. Furthermore, conventional resource planning tools are not integrated with an external calendaring system so that usage statistics regarding resources cannot be readily calculated.

### SUMMARY

In one aspect, first data identifying a resource, a calendared appointment associated with the resource, and a participant (e.g., a person or other entity attending the calendared appointment) in the calendared appointment may be received. The first data may then be associated with second data (e.g., at least one link to information available via the communications network and/or a data file). Subsequently, third data may be transmitted to a node associated with the participant to modify the calendared appointment to include the second data. Optionally, the first data may be generated using a calendaring system (e.g., Outlook, Eudora, NetMail, etc.).

A calendared appointment may, for example, be an appointment made at a client computer using a calendaring system between one or more attendees that have scheduled use of the resource. In one example, the calendared appointment is a sales meeting between two individuals and the resource might be a conference room. In another variation, the calendared appointment pertains to a visit to a customer by a salesperson and the resource is a product sample. In some calendaring systems, the resource may be listed as an additional attendee in the activity in the same fashion as an individual. In other calendaring systems, resources are provided with separate classifications.

Prior to the generation of the calendared appointment, a unique identifier may be associated with the resource to facilitate scheduling of the resource. The unique identifier may be a number, an alphanumeric string, an e-mail address, a groupware address, and the like. This unique identifier may be used to route the data identifying a resource and a calendared appointment associated with the resource over the communications network.

In some variations, the first data may be stored on a groupware server (e.g., an Exchange server). The groupware server may also transmit the first data over the communications network. With a groupware arrangement, a groupware identification may be assigned to the resource. Prior to the associating of the received first data, the groupware identification may be associated with the resource and/or translated to a unique identification compatible with a recipient.

After the first data is received, it may be verified that the resource is available during a specified time period. In one variation, the availability determination may be made by a groupware server coupled to the calendaring system that maintains calendaring information. Alternatively, the availability determination may be based on polling or otherwise accessing a database (e.g., data repository) associated with the resource to obtain scheduling data for the resource. If the resource is available, confirmation data may be transmitted over the communications network. Optionally, no further data may be communicated (i.e., the lack of a response indicates availability). Similarly, if the resource is not available, data indicating the unavailability may be transmitted over the communications network or no further data may be communicated (i.e., lack of a confirmation indicates that the resource is not available).

In some variations, the second data available via the communications network may be stored in a data repository. If the second data comprises links to information (e.g., links to a user manual for an LCD projector, etc.), these links may be transmitted over the communications network to, for example, a calendaring system. The calendaring system may then make the links available to all other attendees in the calendared appointment (e.g., the links may be added to the information regarding the calendared appointment/appointment). If the second data comprises a data file, the data file may be transmitted over the communications network to the calendaring system. In some variations, the data file may be an attachment to the message in which the calendared appointment is accepted.

One or more entities that utilize the resource during the calendared appointment (e.g., the entity initiating the calendared appointment and/or other entities attending the calendared appointment) may also be determined. These entities may be business entities, individuals, and the like. Based on this determination, the method may optionally calculate usage of the resource by the one or more entities and/or cost centers associated such entities. These calculations may be used for a wide variety of resource planning purposes. For example, the entities or their respective cost centers may be billed for their usage of the resource, maintenance records for the resource may be updated, utilization metrics may be calculated, and the like. Usage statistics without regard to the one or more entities may also be calculated using, for example, a resource planning system, based, in part, on a length of time of the calendared appointment.

With some resources, there may be further ancillary or complimentary resources that are to be used in connection with the resource of the calendared appointment. For example, if the resource is a conference room, an LCD projector might typically also be reserved. In these scenarios, the identified resource may be associated with at least one ancillary resource, and additional data may be transmitted to the communications network to add the at least one ancillary resource to the calendared appointment. In other words, these additional resources may comprise attendees in the calendared appointment in the same fashion as the identified resource.

In another aspect, an apparatus may comprises a receiver, an association unit, and a transmitter. The receiver may be operable to receive first data identifying a resource, a calendared appointment associated with the resource, and a participant in the calendared appointment. The association unit may be operable to associate the first data with second data. The transmitter may be operable to transmit third data to a node associated with the participant to modify the calendared appointment to include the second data. In addition, in some variations, the apparatus may be coupled to a calendaring system that is operable to generate calendared appointments for resources.

In an interrelated aspect, data identifying a resource and a calendared appointment associated with the resource via a communications network may received. After this data is received, a usage statistic for the resource may be calculated based on a length of time of the calendared appointment.

In yet another interrelated aspect, an apparatus may comprise a receiver and a calculation unit. The receiver may be operable to receive data identifying a resource and a calendared appointment associated with the resource via a communications network. The calculation unit may be operable to calculate a usage statistic for the resource based on a length of time of the calendared appointment. Such usage statistics may be used for a wide variety of purposes, including without limitation, maintenance cycles for resources, billing of costs associated with using the resource, resource optimization and the like. In addition, the apparatus may optionally be coupled to a calendaring system which generates a calendared appointment (e.g., a meeting request) for resources.

Computer program products, tangibly embodied in information carriers are also described. Such computer program products cause a data processing apparatus to conduct one or more operations described herein.

Similarly, systems are also described that may include a processor and a memory coupled to the processor. The memory may encode one or more programs that cause the processor to perform one or more of the method acts described herein.

The subject matter described herein provides many advantages. For example, users may reserve resources using conventional calendaring systems, such as Outlook, which minimizes training costs, reduces complexity, and increases user satisfaction as compared to ERP resource planning tools. In addition, resource booking and appointment management may be integrated into a single user application. Moreover, the current subject matter can be used to readily provide resource planning metrics regarding the resources of an enterprise without complicated and expensive integration of a client-based calendaring system.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram of a method for transmitting data associated with a resource to modify a calendared appointment;

FIG. 2 is a schematic diagram of an apparatus operable to transmit data associated with a resource to modify a calendared appointment;

FIG. 3 is a process flow diagram of a method for calculating a usage statistic for a resource;

FIG. 4 is a schematic diagram of an apparatus operable to calculate a usage statistic for a resource;

FIG. 5 is a schematic diagram of a system for generating a calendared appointment for a resource that is useful for understanding and implementing the subject matter described herein; and

FIG. 6 is a process flow diagram illustrating a technique for generating an appointment for a resource and modifying the appointment to include data associated with the resource that is useful for understanding and implementing the subject matter described herein.

### DETAILED DESCRIPTION

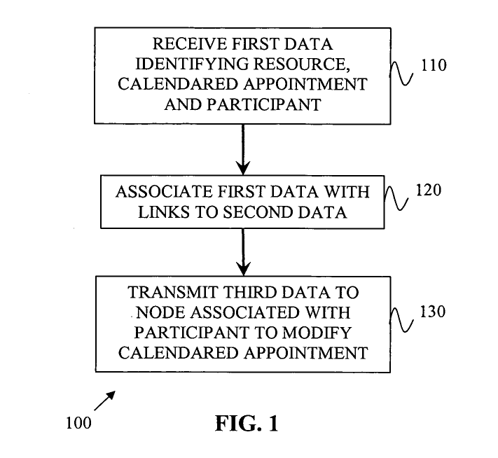

FIG. 1 illustrates a process flow diagram of a method 100 which includes, at 110, receiving first data identifying a resource (e.g., a conference room, equipment, a slot of time of a service provider, etc.), a calendared appointment associated with the resource (e.g., a specifically designated block of time for use of the resource by one or more identified entities), and a participant in the calendared appointment (an individual or an entity attending the appointment, etc.). The first data, at 120, is associated with second data (e.g., data files and/or at least one link associated with web pages containing maintenance records, specification sheets, operation manuals, etc.). Subsequently, at 130, third data (e.g., an acknowledgement and/or acceptance of request for calendared appointment including at least one link and/or having a data file attached thereto) is transmitted over a communications network to a node associated with the participant (e.g., using an e-mail address) to modify the calendared appointment to include the second data.

FIG. 2 illustrates an apparatus 200 that comprises a receiver 210, an association unit 220, and a transmitter 230. The receiver 210 is operable to receive first data identifying a resource, a calendared appointment associated with the resource, and a participant in the calendared appointment. The association unit 220 is operable to associate the first data with links to second data (e.g., at least one link to data available over a communications network and/or a data file). The transmitter 230 is operable to transmit third data to a node associated with the participant to modify the calendared appointment to include the second data. In addition, the apparatus 200 may optionally be coupled to a calendaring system 240 (e.g., Outlook, Eudora, NetMail, etc.) which is operable to generate calendared appointments (e.g., by initiating a meeting request) for resources.

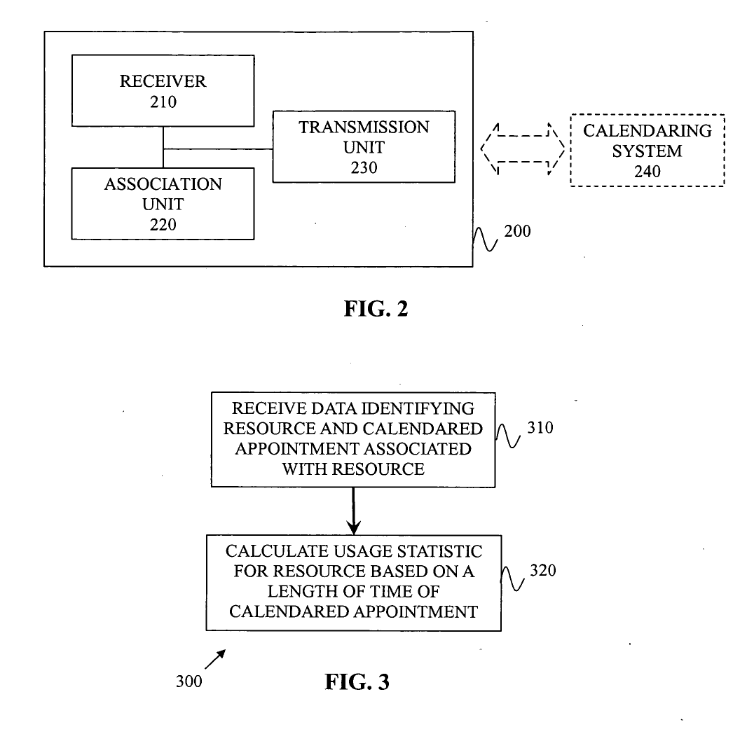

FIG. 3 illustrates a process flow diagram of a method 300 that is interrelated to the method 100 of FIG. 1. The method 300, at 310, receives data identifying a resource and a calendared appointment associated with the resource via a communications network. After this data is received, at 320, a usage statistic for the resource is calculated based on a length of time of the calendared appointment.

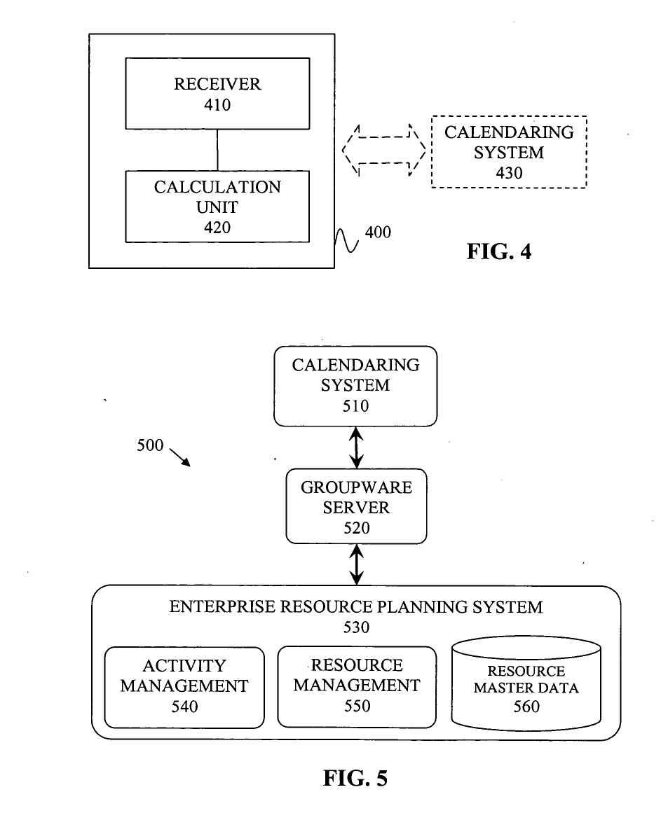

FIG. 4 illustrates an apparatus 400 that is interrelated to the apparatus 300 of FIG. 3 that comprises a receiver 410 and a calculation unit 420. The receiver 410 is operable to receive data identifying a resource and a calendared appointment associated with the resource via a communications network. The calculation unit 420 is operable to calculate a usage statistic for the resource based on a length of time of the calendared appointment. In addition, the apparatus 400 may optionally be coupled to a calendaring system 430 that is operable to generate a calendared appointment (e.g., a meeting request) for resources.

The following provides information useful for understanding and implementing the subject matter described herein as well as optional variations that may be implemented singly or in combination depending on the desired configuration.

FIG. 5 illustrates a system 500 for generating a calendared appointment for a resource and associating the calendared appointment with a data entry in a data repository. Using a client-based calendaring system 510, such as Outlook, Outlook Express, Eudora, NetMail and the like, a user generates an appointment involving at least one attendee and at least one resource. The attendee may, for example, be an individual or an entity (e.g., a company). The resource may, for example, be an item, service (e.g., service appointment for repair technician), or individual.

In one example, a user of the calendaring system 510 makes an appointment for himself, two other co-workers, and reserves a conference room where a meeting with the co-workers will take place. In the calendaring system 510, the conference room is assigned a unique identification, such as an e-mail address or a groupware identification (e.g., confroom05@companyresources.com). The unique identity may be assigned in response to a first meeting request received by a mail server associated with the resource. Alternatively, the unique identification may be assigned at the calendaring system 510. Once the appointment has been finalized by the user, a meeting request is sent to each of the attendees which includes the co-workers and the conference room. This meeting request may take the form of data complying with the iCalendar standard (RFC2445).

Each of the co-workers may ignore the meeting request or automatically or manually reply whether they will attend. With some calendaring systems 510, a resource has a special designation and automatically accepts all meeting requests when it is available. In other variations, a groupware server 520 coupled to the calendaring system 510 stores calendar information associated with the resource and accepts/denies a calendared appointment for the resource based on its availability. The appointment may be replicated by a mail server, such as the groupware server 520 associated with the resource, on a enterprise resource planning system 530. In some variations, the groupware server 520 may translate a groupware identification associated with the resource with a unique identifier compatible with the resource planning system 520.

The enterprise resource planning system 530 may comprise an activity management unit 540, a resource management 550 unit, and a resource master data repository 560. The activity management unit 540 may associate the resource and the appointment with an entry for the resource in the resource master data repository 560. The resource master data repository 560 may, for example, store an entry for the resource comprising information such as scheduling and data files and/or link data. The data files and/or the link data may be used for a wide variety of activities including, cost assignment, analytics, tracking, categorization, billing, and the provision of additional data associated with the resource. These statistics may, in some variations, be based on an amount of time a resource is used (which in turn is based on a length of time of a calendared appointment).

The enterprise resource planning system 530 may replicate the appointment back to the groupware server 520 including additional information obtained from the master resource data entry associated with the resource. The additional information may take the form of an attached file or a link to data (accessible via the Internet, a LAN, a WAN, etc.). For example, the latest instruction manual for a tool for a service technician or demonstration slides for a product sample or a link (e.g., URL) thereto may be attached to the appointment (and/or to the response to the meeting request). By providing links rather than an attachment, the additional information may be periodically modified prior to the time of the appointment (e.g., safety warnings regarding resource, new product release, etc.). In addition, the enterprise resource planning system 530 may also determine whether the resource is available during the appointment time and provide a response to the calendaring system 510 indicating the same.

The enterprise resource planning system 530 may “invite” resources ancillary to be-utilized during the calendared appointment. For example, a company automobile (e.g., an ancillary resource, etc.) may be reserved in response to a salesperson making an appointment reserving a sample product (e.g., originally “invited” resource) to demonstrate to a potential customer in the fashion described above. The enterprise resource planning system 530 may internally identify the ancillary resources as unavailable during the appointment and/or it may send a request to the calendaring system to “invite” the ancillary resource to participate in the calendared appointment.

The resource management unit 550 may monitor the usage of the resource (based, in part, on a length of the calendared appointment) and generate one or more metrics therefrom. For example, costs of the resource usage may be assigned to cost centers (meeting rooms, tools etc.). Reports about tool utilization ratios may be generated (e.g. bottleneck analysis, is number of identical tools frequently booked simultaneously, etc.). Maintenance cycles and/or lifetimes of tools may be tracked (e.g., trigger maintenance of a tool if the cumulated usage hours since the last maintenance is exceeded; average lifetime of a tool type, etc.). Reports regarding utilization of resources by employees (e.g., employee Miller frequently and unnecessarily reserves conference rooms). Work management integration and profitability reports may be generated. The usage information may also be form a basis to categorize the resource (i.e., resource is of category service, tool, sub category drilling machine, etc.). Third parties may be billed based on use of the resources (e.g., for service orders).

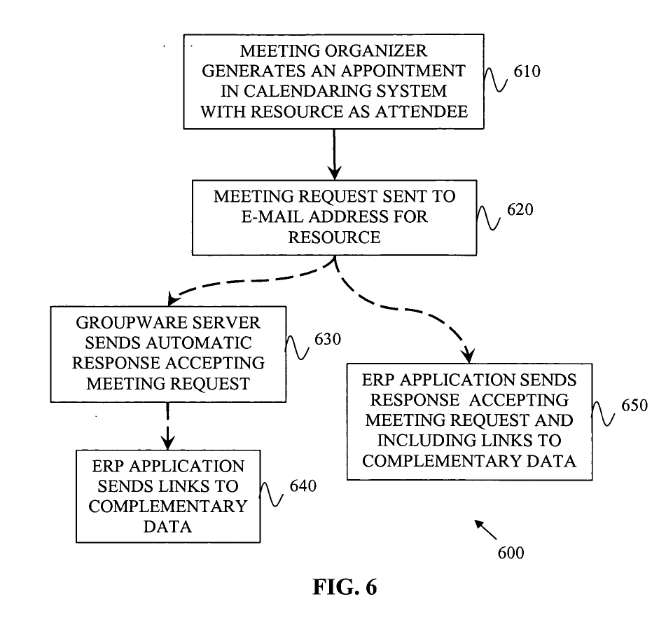

FIG. 6 illustrates is a process flow diagram of a technique 600 relating to the generation of an appointment. At 610, a meeting organizer, using a calendaring system such as MS Outlook, generates an appointment in which a resource is listed as an attendee. The resource may have an associated e-mail address uniquely identifying the resource. After generating the appointment, at 620, a meeting request, generated by the calendaring system, is sent to the e-mail address for the resource.

In one variation, at 630, the meeting request is routed to a groupware server that determines whether the resource has previously been scheduled for a conflicting appointment. If the resource is available, a response is sent to the node associated with the calendaring system accepting the appointment. In addition, at 640, the meeting request is routed to the ERP application which sends an attached data file and/or at least one link to data complementary to that of the resource to the node associated with the calendaring system. Thereafter, the calendaring system modifies the appointment such that each participant may be provided with the attached data file and/or the at least one link when information associated with the calendared appointment is accessed (i.e., the attached data file and/or at least one link may be available in a box within a window providing the details about the appointment).

In another variation, the meeting request is routed to a node associated with an ERP application (or other planning application). The ERP application, at 650, determines whether the resource is available by, for example, polling a database to obtain information related to the resource. The ERP application may also poll a database to obtain links to data complementary to the resource (e.g., a user manual, repair history, etc.). Thereafter, a response may be sent to a node associated with the calendaring system accepting the meeting request and including at least one of a data file and a link to complementary data associated with the resource.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “information carrier” comprises a “machine-readable medium” that includes any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal, as well as a propagated machine-readable signal. The term “machine-readable signal” refers to any signal used to provide machine instructions and/or data to a programmable processor. To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. A computer-implemented method comprising:
receiving first data identifying a resource, a calendared appointment associated with the resource, and a participant in the calendared appointment;
associating the first data with second data; and
transmitting third data via a communications network to a node associated with the participant to modify the calendared appointment to include the second data.

2. A method as in claim 1, wherein the second data comprises at least one link to information available via the communications network.

3. A method a in claim 1, wherein the second data comprises a data file.

4. A method as in claim 1, further comprising: generating, by a calendaring system, the first data.

5. A method as in claim 4, further comprising: storing the first data on a groupware server.

6. A method as in claim 5, further comprising: transmitting, by the groupware server, the first data over the communications network.

7. A method as in claim 1, further comprising: associating the resource with a unique identifier.

8. A method as in claim 7, wherein the unique identifier is an e-mail address.

9. A method as in claim 1, further comprising: verifying that the resource is available during a time period specified in the first data.

10. A method as in claim 9, further comprising: transmitting fourth data indicating whether the resource is available during the time period specified in the received first data.

11. A method as in claim 9, wherein a groupware server verifies the availability of the resource.

12. A method as in claim 1, further comprising: determining one or more entities utilizing the resource during the calendared appointment.

13. A method as in claim 12, further comprising: calculating a usage statistic of the resource by the one or more entities based on a length of time of the calendared appointment.

14. A method as in claim 1, further comprising:
associating the identified resource with at least one ancillary resource; and
transmitting fifth data via the communications network to add the at least one ancillary resource as an additional participant to the calendared appointment.

15. An apparatus comprising:
a receiver to receive first data identifying a resource, a calendared appointment associated with the resource, and a participant in the calendared appointment;
an association unit to associate the first data with second data; and
a transmitter to transmit third data via a communications network to a node associated with the participant to modify the calendared appointment to include the second data.

16. An apparatus as in claim 15, wherein the second data comprises at least one link to information available via the communications network.

17. An apparatus as in claim 15, wherein the second data comprises a data file.

18. An apparatus as in claim 14, further comprising a data repository for storing at least one of the first and second data.

19. An apparatus as in claim 15, further comprising an enterprise resource planning unit coupled to the data repository for calculating a usage statistic for the resource.

20. A method comprising:
receiving data identifying a resource and a calendared appointment associated with the resource via a communications network; and
calculating a usage statistic for the resource based on a length of time of the calendared appointment.
